(19) United States
(12) Patent Application Publication
(10) Pub. No.: US 2004/0171319 A1
(43) Pub. Date: Sep. 2, 2004

(54) Fabric of ultra fine yarn with excellent wash fastness and sunlight fastness

(76) Inventor: Joon-Young Yoon, Kyungsangbuk-do (KR)

Correspondence Address: BIRCH STEWART KOLASCH & BIRCH, PO BOX 747, FALLS CHURCH, VA, 22040-0747, US

(21) Appl. No.: 10/475,678

(22) PCT Filed: Apr. 26, 2002
(86) PCT No.: PCT/KR02/00778

(30) Foreign Application Priority Data
Apr. 26, 2001 (KR) 2001/22596

(51) Int. Cl. B32B 3/00

(52) U.S. Cl. 442/59

(57) ABSTRACT

The present invention relates to a fabric of ultra fine yarn with excellent wash fastness and light fastness. More specifically, the fabric of ultra fine yarn of the present invention, which comprises ultra fine yarn with mono-filament denier of 0.001˜0.3 denier and a thick denier yarn with mono-filament denier of 0.5˜5 denier, is characterized in that: the ultra line yarn includes a dope dyed component selected from the group consisting of carbon black, pigments and dyestuffs, and the fabric has a wash fastness of more than level 3 and a light fastness of more than level 5. Since the ultra fine yarn constituting the fabric includes a dope dyed component such as carbon black or the like, no additional dyeing process is required and wash fastness and light fastness are excellent.

### BACKGROUND OF THE INVENTION

1. Field of the Invention

The present invention relates to a fabric of ultra fine yarn with excellent wash fastness and light fastness.

If a fiber becomes fined, its bending strength becomes weakened. Accordingly, since fabrics produced with ultra fine denier fiber have very soft touch, researches in connection with producing such ultra fine denier fiber on a commercial scale are developing very actively. Also, development of the technology which is capable of producing synthetic yarn extremely finely leads to great improvement of the value of the goods of sensitive materials for clothes.

1. Description of Related Art

Generally, a process of preparing ultra fine denier fiber is divided into three processes: a direct spinning process; a bicomponent division type spinning process; and a bicomponent dissolution type spinning process. In the direct spinning process, it is possible to prepare ultra fine denier fiber of 0.3˜0.5 denier. In the bicomponent division type spinning process, it is possible to prepare ultra fine denier fiber of 0.2 denier. In the bicomponent dissolution type spinning process, it is possible to prepare ultra fine denier fiber of 0.001 denier or below.

Producing goods with ultra fine denier fiber are developing in variety in connection with textile applications. However, producing goods with ultra fine denier fiber are not developing in connection with knitting applications, particularly, fabric of ultra fine yarn applications, due to the several drawbacks generated in warping and subsequent process.

In case that the ultra fine denier fiber of 0.3˜0.5 denier prepared by means of the direct spinning process is applied to a warp knit, warping processability and weaving processability are very poor since numerous filaments are scattered. Furthermore, the specific surface area of yarn is increased to thus make raising processability and processability poor, and the warp knit thus prepared is non-uniform in its buffed fiber and is very inferior in appearance.

In case that the ultra fine denier fiber of 0.2 denier prepared by means of the bicomponent division type conjugate spinning process consisting of nylon/polyester is applied to a warp knit, warping processability, weaving processability and raising processability of the warp knit are very poor since the nylon is isolated from the polyester by means of the tension and friction in warping and weaving because the nylon and the polyester are incompatible with each other. Furthermore, appearance of the prepared warp knit is very poor due to non-uniform of buffed fiber. Moreover, since the nylon and the polyester are mixed, the warp knit is difficult to dyestuffs and also its color fastness is low.

In case that a warp knit is prepared by the sea-island type conjugate fiber of 0.001˜0.3 denier prepared by using alkali easy soluble copolymerized polyester as a sea component and regular polyester as an island component by means of the bicomponent dissolution type spinning process, warping processability, raising processability and weaving processability of the warp knit are good; however, the wash fastness and light fastness of the warp knit are low due to poor dyeing processability which is characteristic of the polyester (island component).

Accordingly, it is an object of the present invention to prepare a fabric of ultra fine yarn with excellent wash fastness and light fastness, which may not be dyestuffsd by weaving a fabric using a sea-island type conjugate fiber, which includes a dope dyed component in fiber forming component, as a warp or weft and then dissolving a sea component of the sea-island type conjugate fiber when producing a fabric of ultra fine yarn.

### SUMMARY OF THE INVENTION

The present invention provides a fabric of ultra fine yarn with excellent wash fastness and light fastness which has excellent warping processability and weaving processability and may omit a dyeing process.

To achieve the above object, the present invention provides a fabric of ultra fine yarn with excellent wash fastness and light fastness, which consists of a ultra fine yarn with mono-filament denier of 0.01˜0.3 denier and a thick denier yarn with mono-filament denier of 0.5˜5 denier, wherein the ultra fine yarn includes a dope dyed component selected from the group consisting of carbon black, pigments and dyestuffs, and the fabric has a wash fastness of more than level 3 and a light fastness of more than level 5.

The present invention wilt now be described in more detail.

Firstly, the fabric of ultra fine yarn of the present invention consists of a ultra fine yarn with mono-filament denier of 0.01˜0.3 denier, which includes a dope dyed component selected from the group consisting of carbon black, pigments and dyestuffs, and a thick denier yarn with mono-filament denier of 0.5˜5 denier. The above ultra fine yarn is formed by weaving a fabric using a bicomponent dissolution type conjugate fiber, which has polyester including a dope dyed component as a fiber forming component and easy soluble polymer as a dissolution component, or a miture yarn thereof as a warp or weft, and then dissolving the dissolution component in the subsequent process. In other words, to improve the processability, the fabric becomes ultra fine after warping and weaving it using the bicomponent dissolution type conjugate fiber as a warp or weft, and then dissolving the dissolution component.

Particularly, according to the present invention, when spinning the sea-island type conjugate fiber, a dope dyed component is added in the fiber forming component in order to improve wash fastness and light fastness of the fabric of ultra fine yarn. As the dope dyed component, more than one component is used from the group consisting of carbon black, pigments and dyestuffs. If the carbon black is solely used, the ultra fine yarn (island component) has a black color. In case that the ultra fine yarn is desired to have other colors different from black, types of pigments or dyestuffs should be properly selected.

For example, the dyestuffs include solvent dyestuffs (products by Eastwell Co., Ltd.) such as Papilion Yellow S-4G, Papilion Red S-G, Papilion Blue S-GL, etc., and the pigments include BASF Corporation products such as Heliogen Blue D 7030, Paliogen Red L 3885, Paliotol Yellow D 1819 Hetiogen, etc. By properly mixing these pigments and dyestuffs of RGB colors, a desired color can be obtained. Moreover, if the content of carbon black in the island component is adjusted to be less than 5% by weight, a fabric of ultra fine yarn with grey color can be produced.

The dope dyed component content is 0.1˜15% by weight with respect to the weight of the fiber forming component (ultra fine yarn). If the dope dyed component content is less than 0.1% by weight, the improvement effect of wash fastness and light fastness is small, or if it is more than 15% by weight, the spinning processability is decreased.

Preferably, the mono-filament denier of the ultra fine yarn is 0.001˜0.3 denier. If the mono-filament denier is more than 0.3 denier, the softness can be reduced. If it is less than 0.001 denier, the softness can be increased but the friction resistance is weakened to thus make the appearance poor.

Meanwhile, as the thick denier yarn constituting the fabric of ultra fine yarn of the present invention, a processed polyester yarn is preferably used. To improve wash fastness and light fastness, the dope dyed component can be contained in 0.1˜15% by weight of thick denier yarn.

Preferably, the mono-filament denier of the thick denier yarn is 0.5˜5 denier. If the mono-filament denier is Less than 0.5 denier, it may be difficult to give proper repulsiveness to the fabric. If the mono-filament denier is more than 5 denier, processability such as warping and weaving properties can be worse, or the repulsiveness of the fabric becomes too large, for thereby making it difficult to exhibit softness of the face.

The process of preparing the fabric of ultra fine yarn according to the present invention will be described more specifically. Firstly, as any one of a warp and weft, a sea-island type conjugate fiber consisting of a fiber forming component, which includes 0.1˜15% by weight of dope dyed component selected from the group consisting of carbon black, pigments and dyestuffs, and a dissolution component, which is a easy soluble polymer, is used. As the remaining warp or weft, a polyester thick denier yarn with mono-filament denier of 0.5˜5 denier is used, thus weaving the fabric.

As the easy soluble polymer, copolymerized polyester with very excellent alkali dissolution speed is most preferably used. For example, the blended composition consisting of (i) copolymerized polyester formed by the copolymerization of an ester unit of ethylene terephthalic acid as a main component, with an ester unit containing metal sulfonates and (ii) a polyethylene glycol having a number average molecular weight of more than 8,000 is used as the easy soluble polymer. In addition, the easy soluble polymer further includes water-easy soluble polyvinyl alcohol or polystyrene or the like. However, the polystyrene is disadvantageous in that the solvent used in dissolution causes environmental contamination.

As a substitute for the sea-island type conjugate fiber, a blended filament yarn can be used, which is produced by mixing the sea-island type conjugate fiber with a high shrinkage yarn having shrinkage rate in boiling water of more than 15%. Moreover, the thick denier yarn includes dope dyed false twist yarn. In weaving, a plain weave, a twill weave, a satin weave and modifications thereof can be used.

Next, by the alkali weight reduction of the thusly woven fabric, the dissolution component (sea component) in the sea-island type conjugate fiber is dissolved to thus achieve a ultra fine yarn.

The fabric of ultra fine yarn of the present invention includes the dope dyed component in the ultra fine yarn, so a dyeing process can be omitted. However, in order to adjust the color of the fabric of ultra fine yarn, an additional dyeing can be performed. In the additional dyeing process, a sufficiently deep color can be obtained even at a concentration of dyestuffs less than 5% o.w.s, and thusly the amount of the dyestuffs to be used can be reduced.

The ultra fine yarn or the ultra fine yarn and thick denier yarn, which constitute the fabric of ultra fine yarn of the present invention, include a black dope dyed component, and thus their wash fastness and light fastness are very excellent. Concretely, the wash fastness is higher than level 2˜3, and the light fastness is higher than level 5. Furthermore, the fabric of ultra fine yarn of the present invention has an excellent processability since it is warped and woven in the sea-island type conjugate fiber state, and at the same time it can achieve a good softness since yarn in the fabric becomes ultra fine as the dissolution component is dissolved in the subsequent process.

### DETAILED DESCRIPTION OF THE EMBODIMENTS

The present invention is now understood more specifically by comparison between examples of the present invention and comparative examples. However, the present invention is not limited to such examples.

### EXAMPLE 1

A fabric of a satin weave is woven by a rapier loom such that densities of a warp and a weft were 132 yarns/inch and 128 yarns/inch, respectively, wherein mixed filament yarn made of a dissolution type conjugate fiber (dope dyed yarn) of 130 denier/48 filaments and a high shrinkage polyester yarn of 30 denier/12 filaments having a shrinkage rate of boiling water of 18% is used in the weft and a polyester false twist yarn (dope dyed yarn) of 75 denier/36 filaments containing 3% by weight of carbon black is used in the warp. The dissolution type conjugate fiber consisting of polyethylene terephthalate containing 3% by weight of carbon black as a fiber forming component and alkali easy soluble copolymerized polyester composed of 5 mole % of polyethylene glycol, 5 mole % of dimethyl-5-sulfoisothphalate, 5 mole % of isophthalic acid and 85 mole % of polyethylene terephthalate as a dissolution component. And the fiber forming component become 0.06 denier after dissolving the dissolution component. The weight reduction of the woven fabric is carried out for 40 minutes in an aqueous NaOH solution having a concentration of 1% o.w.s and a temperature of 98° C., for thereby preparing a finished fabric. At this time, a dyeing process is not performed. The results of evaluation of the quality properties of the finished fabric are indicated in Table 1.

### EXAMPLE 2

The finished fabric prepared in the same process and conditions as in Example 1 is dyestuffsd with a black disperse dyestuffs (2% o.w.f. oncentration) by a typical rapid dyeing machine for 45 minutes at 120° C. (PH=4.5). And then the dyestuffsd fabric is washed and finally set at 160° C. The results of evaluation of the quality properties of the finished fabric thus dyestuffsd are indicated in Table 1.

### EXAMPLE 3

A fabric of a satin weave is woven by a rapier loom such that densities of a warp and a weft were 132 yarns/inch and 128 yarns/inch, respectively, wherein an air textured filament yarn made of a dissolution type conjugate fiber (dope dyed yarn) of 130 denier/48 filaments and a high shrinkage polyester yarn of 30 denier/12 filaments having shrinkage rate of boiling water of 18% is used in the weft and a polyester false twist yarn (non-dope dyed yarn) of 75 denier/36 filaments is used in the warp. The dissolution type conjugate fiber consisting of polyethylene terephthalate containing 5% by weight of Papilion Yellow S-4G (products by Eastwell Co., Ltd.), which is a solvent dyestuffs, as a fiber forming component and alkali easy soluble copolymerized polyester composed of 5 mole % of polyethylene glycol, 5 mole % of dimethyl-5-sulfoisothphalate, 5 mole % of isophthalic acid and 85 mole % of polyethylene terephthalate as a dissolution component. And the fiber forming component become 0.06 denier after dissolving the dissolution component. The weight reduction of the woven fabric is carried out for 40 minutes in an aqueous NaOH solution having a concentration of 1% o.w.s and a temperature of 98° C., for thereby preparing a finished fabric. At this time, a dyeing process is not performed. The results of evaluation of the quality properties of the finished fabric are indicated in Table 1.

### EXAMPLE 4

A fabric of a satin weave is woven by a rapier loom such that densities of a warp and a weft were 132 yarns/inch and 128 yarns/inch, respectively, wherein a dissolution type conjugate fiber (dope dyed yarn) is used in the weft and a polyester false twist yarn (non-dope dyed yarn) of 75 denier/36 filaments is used in the warp. The dissolution type conjugate fiber consisting of polyethylene terephthalate containing 4% by weight of Heliogen Blue D 7030 (products by BASF.), which is a pigment, as a fiber forming component and alkali easy soluble copolymerized polyester composed of 5 mole % of polyethylene glycol, 5 mole % of dimethyl-5-sulfoisothphalate, 5 mole % of isophthalic acid and 85 mole % of polyethylene terephthalate as a dissolution component. And the fiber forming component become 0.06 denier after dissolving the dissolution component. The weight reduction of the woven fabric is carried out for 40 minutes in an aqueous NaOH solution having a concentration of 1% o.w.s and a temperature of 98° C., for thereby preparing a finished fabric. At this time, a dyeing process is not performed. The results of evaluation of the quality properties of the finished fabric are indicated in Table 1.

### Comparative Example 1

A fabric of a satin weave is woven by a rapier loom such that densities of a warp and a weft were 132 yarns/inch and 128 yarns/inch, respectively, wherein an air textured filament yarn made of a dissolution type conjugate fiber (non-dope dyed yarn) of 130 denier/48 filaments and a high shrinkage polyester yarn of 30 denier/12 filaments having a shrinkage rate of boiling water of 18% is used in the weft and a polyester false twist yarn (non-dope dyed yarn) of 75 denier/36 filaments is used in the warp. The dissolution type conjugate fiber consisting of polyethylene terephthalate as a fiber forming component and alkali easy soluble copolymerized polyester composed of 5 mole % of polyethylene glycol, 5 mole % of dimethyl-5-sulfoisothphalate, 5 mole % of isophthalic acid and 85 mole % of polyethylene terephthatate as a dissolution component. And the fiber forming component become 0.06 denier after dissolving the dissolution component. The weight reduction of the woven fabric is carried out for 40 minutes in an aqueous NaOH solution having a concentration of 1% o.w.s and a temperature of 98° C., and then is dyestuffsd with a black disperse dyestuffs (12.5% o.w.f. concentration) by a typical rapid dyeing machine for 45 minutes at 120° C. (PH=4.5), for thereby preparing a finished fabric. The results of evaluation of the quality properties of the finished fabric are indicated in Table 1.

TABLE 1
Processability and fabric of ultra fine yarn properties.

| | | | Ultra fine fabric properties | | | |
|---|---|---|---|---|---|---|
| | | | | | | Blackness |
| | Processability | | Wash | Light | Blackness | After |
| Class | Warping | Weaving | Fastness | Fastness | Before dyeing | dyeing |
| Example 1 | ⊚ | ⊚ | LeveL 5 | Level 7 | 14.3 | — |
| Example 2 | ⊚ | ⊚ | LeveL 3 | Level 6 | 14.3 | 13.4 |
| Example 3 | ⊚ | ⊚ | Level 4-5 | Level 7 | — | — |
| Example 4 | ⊚ | ⊚ | Level 4-5 | Level 7 | — | — |
| Comparative | ⊚ | ⊚ | Level 1 | Level 3 | — | 14.3 |
| Example 1 | | | | | | |

In the present invention, the quality properties of the fabric of ultra fine yarn are evaluated by the following methods.

Wash Fastness

This was evaluated by the KS K 0430 A1 method.

Light Fastness

This was evaluated by the KS K 0700 method.

Blackness (L value)

This was evaluated by using Data Color Spectra Flash 600.

Weaving Processability

Weaving processability is evaluated by checking the stop times/hour of weaving machine(rapier loom) due to yarn defect at 320 RPM. If the stop times/hour is naught, it is excellent(⊚). If the stop times/hour is one or two, it is ordinary(Δ). If the stop times/hour is more than 3 times, it is poor(x). The stop times/hour of weaving machine is calculated by dividing the total stop times of weaving machine in a day into total weaving time(24 hour).

Warping Processability

Warping processability is evaluated by checking the stop times/hour of warping machine due to yarn defect at a warping speed of 500 m/min. if the stop times/hour is naught, it is excellent(⊚). If the stop times/hour is one or two, it is ordinary(Δ). If the stop times/hour is more than 3 times, it is poor(x). The stop times/hour of warping machine is calculated by dividing the total stop times of warping. machine in warping the yarn of 9 kg into total warping time.

### Industrial Applicability

As described above, the fabric of ultra fine yarn according to the present invention has excellent wash fastness and light fastness since the ultra fine yarn constituting the fabric contains the dope dyed component. Furthermore, if an additional dyeing is carried out, a sufficiently deep color can be obtained even the amount of dyestuffs to be used is reduced. As the result, the fabric of the present invention is useful for materials of artificial leathers or ladies' clothes.

What is claimed is:

1. A fabric of ultra fine yarn with excellent wash fastness and light fastness, comprising a ultra fine yarn with mono-filament denier of 0.001˜0.3 denier and a thick denier yarn with mono-filament denier of 0.5˜5 denier, wherein the ultra fine yarn includes a dope dyed component selected from the group consisting of carbon black, pigments and dyestuffs, and the fabric has a wash fastness of more than level 3 and a light fastness of more than level 5.

2. The fabric of ultra fine-yarn of claim 1, wherein the dope dyed component content in the ultra fine yarn is 0.1˜15% by weight.

3. The fabric of ultra fine yarn of claim 1, wherein the thick denier yarn includes the dope dyed component.

4. The fabric of ultra fine yarn of claim 1, wherein the ultra fine yarn and the thick denier yarn are mainly composed of polyester.
